(19) United States
(12) Patent Application Publication
(10) Pub. No.: US 2024/0306545 A1
(43) Pub. Date: Sep. 19, 2024

(54) WINDROWER IMPLEMENT WITH AUTOMATIC MERGER ATTACHMENT CONTROL

(71) Applicant: DEERE & COMPANY, MOLINE, IL (US)

(72) Inventors: Tyler J. Bouslog, Keota, IA (US); Hunter T. Kelderman, Ottumwa, IA (US)

(21) Appl. No.: 18/184,217

(22) Filed: Mar. 15, 2023

(51) Int. Cl. A01D 57/30

(52) U.S. Cl. CPC A01D 57/30

(57) ABSTRACT

A windrower implement includes a merger controller operatively coupled to a merger attachment for controlling the merger attachment between a deployed position and a stowed position. The merger controller receives a user command selecting one of a single pass windrow configuration in which the windrow is formed from a belly pass, or a double pass windrow configuration in which the windrow is formed from the belly pass and a first merger pass. When the double pass windrow configuration is selected, the merger controller automatically controls the merger attachment into the stowed position when executing the belly pass for the double pass windrow configuration and then automatically controls the merger attachment into the deployed position when executing the first merger pass for the double pass windrow configuration.

### TECHNICAL FIELD

The disclosure generally relates to a windrower implement having a merger attachment, and a method of controlling the merger attachment.

### BACKGROUND

A windrower implement is an agricultural machine that cuts standing crop material while moving through a field, and forms the cut crop material into a swath or windrow. Typically, the windrower implement forms the windrow on and along a general longitudinal centerline of the windrower implement, generally between the left and right ground engaging devices, e.g., tires or tracks. The windrower implement may be equipped with a merger attachment. The merger attachment is configured to form the windrow laterally offset from the centerline of the windrower implement, generally outside the left or right ground engaging devices. The merger attachment may be deployed to form the windrow at an offset position relative to the centerline of the windrower implement, or may be stowed and disengaged, whereby the windrow is formed generally along the centerline of the windrower implement.

When harvesting crop material from a field, the windrower implement typically makes several parallel passes through the field with each pass cutting a width of the crop material. An operator of the windrower implement may control the windrower implement to execute a single pass windrow configuration in which the operator keeps the merger attachment continuously disengaged for each respective pass such that each respective pass through the field generates a respective windrow aligned with the longitudinal centerline of the windrower implement during that respective pass. The operator may alternatively control the windrower implement to execute a double pass windrow configuration in which the operator disengages the merger attachment while executing a belly pass, whereby the windrow is formed along the centerline of the windrower implement. After completing the belly pass, the operator aligns the windrower implement immediately adjacent to the belly pass with the merger attachment deployed to execute a first merger pass. While executing the first merger pass, the merger attachment deposits the crop material from the first merger pass on or next to the windrow formed from the belly pass, thereby placing the windrow from two adjacent passes through the field together as a single windrow. The operator may alternatively control the windrower implement to execute a triple pass windrow configuration by completing the double pass windrow configuration and then executing a second merger pass on the opposing side of the belly pass in a direction opposite to the first merger pass. In so doing, the windrow from three respective passes may be deposited together to form a single larger windrow.

Executing the double pass windrow configuration and the triple pass windrow configuration requires the operator to continuously engage and disengage the merger attachment for the current pass through the field, e.g., the belly pass, the first merger pass or the second merger pass. In addition to controlling the engagement of the merger attachment, the operator must also control the other aspects of the windrower implement, such as raising and lowering a cutter head unit while making headland turns, steering the windrower implement, controlling the throttle, etc. Accordingly, it is common for the operator to fail to properly and timely engage or disengage the merger attachment for the current pass through the field while executing the double pass windrow configuration of the triple pass windrow configuration.

### SUMMARY

A windrower implement is provided. The windrower implement includes a frame extending along a central longitudinal axis between a forward end and a rearward end relative to a direction of travel during operation. An implement head is attached to the frame proximate the forward end thereof. The implement head is operable to cut standing crop material and discharge cut crop material in a rearward direction along the central longitudinal axis. A merger attachment is coupled to the frame rearward of the implement head. The merger attachment is moveable between a deployed position and a stowed position. When in the deployed position, the merger attachment is positioned relative to the implement head to receive discharged crop material from the implement head and convey the crop material laterally relative to the central longitudinal axis to form a windrow laterally offset from the central longitudinal axis. When in the stowed position, the merger attachment is positioned relative to the implement head to not receive discharged crop material from the implement head to form the windrow substantially aligned with the central longitudinal axis along a center line of the frame. A merger controller is operatively coupled to the merger attachment for controlling movement of the merger attachment between the deployed position and the stowed position. The merger controller includes a processor and a memory having a merger control algorithm stored thereon. The processor is operable to execute the merger control algorithm to receive a user command selecting one of a single pass windrow configuration in which the windrow is formed from a belly pass, and a double pass windrow configuration in which the windrow is formed from a belly pass and a first merger pass. When either the single pass windrow configuration or the double pass windrow configuration is selected, the merger controller automatically controls the merger attachment into the stowed position when executing the belly pass for the single pass windrow configuration and the double pass windrow configuration. When the double pass windrow configuration is selected, the merger controller automatically controls the merger attachment into the deployed position when executing the first merger pass for the double pass windrow configuration.

In one aspect if the disclosure, the windrower implement may include a location sensor that is operable to detect data related to a location of the head implement. The processor may be operable to execute the merger control algorithm to determine a current location of the head implement and direction of movement of the head implement from the data detected by the location sensor.

In one aspect of the disclosure, the processor may be operable to execute the merger control algorithm to determine a location of the windrow formed during the belly pass and save the location of the windrow formed during the belly pass in the memory as a windrow track location.

In one aspect of the disclosure, when the double pass windrow configuration is selected, the processor may be operable to execute the merger control algorithm to recognize the beginning of the first merger pass from the current location of the head implement, the direction of movement of the head implement and the windrow track location.

In one aspect of the disclosure, when the double pass windrow configuration is selected, the processor may be operable to execute the merger control algorithm to automatically control the merger attachment into the deployed position upon recognizing the beginning of the first merger pass.

In one aspect of the disclosure, the processor may be operable to execute the merger control algorithm to receive the user command selecting one of the single pass windrow configuration, the double pass windrow configuration, and a triple pass windrow configuration. When the triple pass windrow configuration is selected, the windrow is formed from the belly pass, the first merger pass and a second merger pass. The first merger pass is executed in a first direction immediately adjacent to the belly pass on a first lateral side of the belly pass. The second merger pass is executed in a second direction that is opposite the first direction, immediately adjacent to the belly pass on a second lateral side of the belly pass, i.e., on an opposite side of the belly pass relative to the first merger pass.

In one aspect of the disclosure, the processor may be operable to execute the merger control algorithm to automatically control the merger attachment into the stowed position when executing the belly pass for the triple pass windrow configuration. When executing the first merger pass and the second merger pass for the triple pass windrow configuration, when selected, the processor may be operable to execute the merger control algorithm to automatically control the merger attachment into the deployed position for both the first merger pass and the second merger pass.

In one aspect of the disclosure, when the triple pass windrow configuration is selected, the processor may be operable to execute the merger control algorithm to recognize the beginning of the first merger pass and the beginning of the second merger pass from the current location of the head implement, a direction of movement of the head implement and a windrow track location of the belly pass.

In one aspect of the disclosure, when the triple pass windrow configuration is selected, the processor may be operable to execute the merger control algorithm to automatically control the merger attachment into the deployed position upon recognizing the beginning of the first merger pass or the second merger pass.

A method of operating a windrower implement is also provided. The method includes entering a user command into a merger controller via an input device to select one of a single pass windrow configuration in which a windrow is formed from a belly pass, a double pass windrow configuration in which the windrow is formed from the belly pass and a first merger pass, or a triple pass windrow configuration in which the windrow is formed from the belly pass, the first merger pass and a second merger pass. The beginning of the belly pass is then determined or established. A merger attachment is controlled via the merger controller into a stowed position at the beginning of the belly pass when any one of the single pass windrow configuration, the double pass windrow configuration, or the triple pass windrow configuration are selected. A beginning of the first merger pass is then determined or established. The merger controller may then automatically control the merger attachment into a deployed position at the beginning of the first merger pass when one of the double pass windrow configuration or the triple windrow configuration are selected.

In one aspect of the disclosure, the method of operating the windrower implement may further include sensing data related to a current location and direction of travel of the windrower implement, and determining the current location and the direction of travel of the windrower implement with the merger controller.

In one aspect of the disclosure, the method of operating the windrower implement may further include determining a location of the windrow formed during the belly pass and saving the location of the windrow formed during the belly pass in the memory as a windrow track location.

In one aspect of the disclosure, the method of operating the windrower implement may further include determining the beginning of the first merger pass from the windrow track location, the current location of the windrower implement and the current direction of travel of the windrower implement.

In one aspect of the disclosure, the method of operating the windrower implement may further include automatically controlling the merger attachment via the merger controller into the deployed position at the beginning of the second merger pass when the triple windrow configuration is selected.

Accordingly, the windrower implement and the process described herein enable automation of the deployment of the merger attachment for the first merger pass and/or the second merger pass when the double windrow configuration or the triple windrow configuration are selected. In so doing, the windrower implement automatically controls the merger attachment into the stowed position at the beginning of the belly pass, and then automatically controls the merger attachment into the deployed position for the first merger pass and/or the second merger pass, thereby relieving the operator of the burden to remember to engage and/or disengage the merger attachment during operation.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic perspective view of a windrower implement.

FIG. 2 is a schematic partial cross sectional side view of the windrower implement.

FIG. 3 is a schematic plan view of a single pass windrow configuration for forming a windrow.

FIG. 4 is a schematic plan view of a double pass windrow configuration for forming a windrow.

FIG. 5 is a schematic plan view of a triple pass windrow configuration for forming a windrow.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

As used herein, “e.g.” is utilized to non-exhaustively list examples, and carries the same meaning as alternative illustrative phrases such as “including,” “including, but not limited to,” and “including without limitation.” As used herein, unless otherwise limited or modified, lists with elements that are separated by conjunctive terms (e.g., “and”) and that are also preceded by the phrase “one or more of,” “at least one of,” “at least,” or a like phrase, indicate configurations or arrangements that potentially include individual elements of the list, or any combination thereof. For example, “at least one of A, B, and C” and “one or more of A, B, and C” each indicate the possibility of only A, only B, only C, or any combination of two or more of A, B, and C (A and B; A and C; B and C; or A, B, and C). As used herein, the singular forms “a”, “an” and “the” are intended to include the plural forms as well, unless the context clearly indicates otherwise. Further, “comprises,” “includes,” and like phrases are intended to specify the presence of stated features, steps, operations, elements, and/or components, but do not preclude the presence or addition of one or more other features, steps, operations, elements, components, and/or groups thereof.

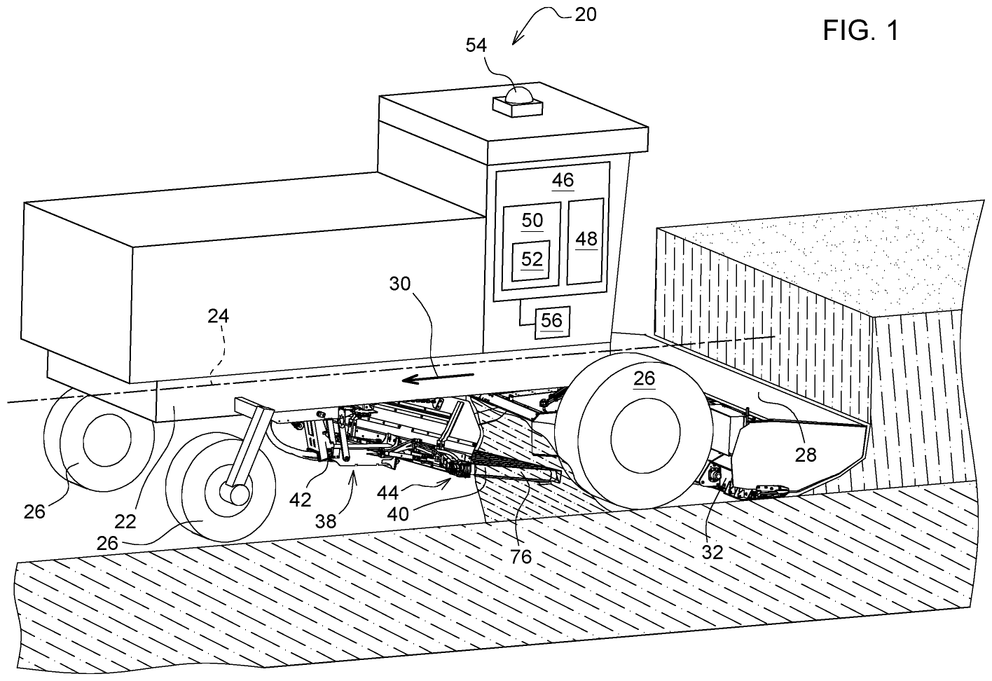

Referring to the Figures, wherein like numerals indicate like parts throughout the several views, a windrower implement is generally shown at 20 in FIG. 1. The exemplary embodiment of the windrower implement 20 shown in the Figures is configured as a self-propelled windrower. However, it should be appreciated that the teachings of this disclosure may be applied to other platforms, such as but not limited to, a drawn implement configured for connection to a tractor. In one implementation, the windrower implement 20 is operable to mow and collect standing crop material in a field, condition the cut crop material as it moves through the windrower implement 20 to improve is drying characteristics, and then return the conditioned, cut crop material to the field in a windrow 78 or swath.

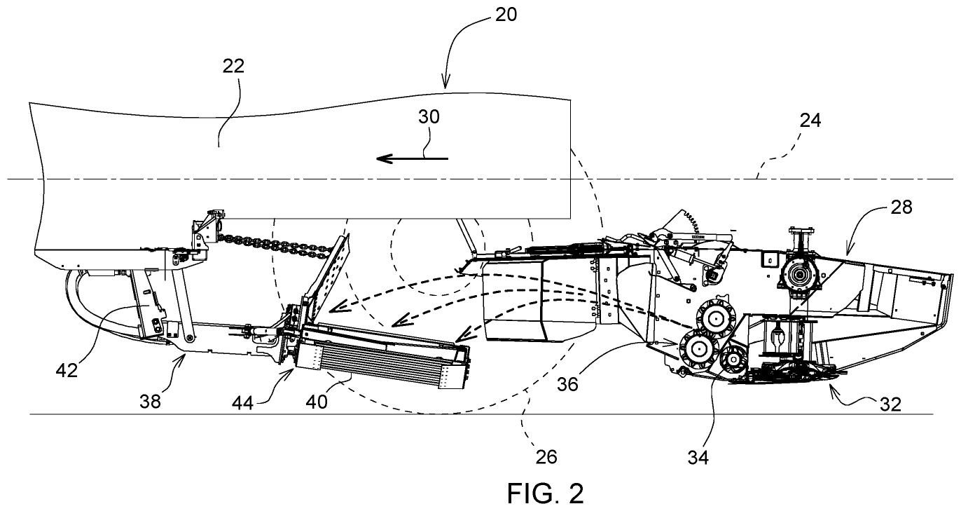

Referring to FIGS. 1-2, the example implementation of the windrower implement 20 includes a frame 22. The frame 22 extends along a central longitudinal axis 24 between a forward end and a rearward end relative to a direction of travel during operation. The central longitudinal axis 24 defines a longitudinal centerline of the windrower implement 20. The frame 22 may include, but is not limited to, the various members, panels, supports, braces, beams, etc., necessary to support the various components and systems of the windrower implement 20 as described below. The windrower implement 20 includes ground engaging devices 26, e.g., tires and/or tracks, which support the frame 22 relative to a ground surface. The ground engaging devices 26 may be powered to move the windrower implement 20 across the ground surface.

The windrower implement 20 further includes an implement head 28. The implement head 28 is attached to the frame 22 proximate the forward end of the frame 22. The implement head 28 is operable to discharge crop material in a rearward direction 30 generally along the central longitudinal axis 24. In addition, the implement head 28 may further cut the crop material and condition the crop material to aid in dry down.

In one implementation, the implement head 28 may include, but is not limited to, a cutting mechanism 32. The cutting mechanism 32 is coupled to the frame 22 and is operable to cut standing crop material in a field. The cutting mechanism 32 may include any mechanism that is capable of cutting the crop material. For example, the cutting mechanism 32 may be embodied as a rotary disc cutter bar. However, the cutting mechanism 32 is not limited to the exemplary embodiment of the rotary disc cutter bar. As such, it should be appreciated that the cutting mechanism 32 may vary from the exemplary embodiment noted herein.

As understood in the art, the rotary disc cutter bar includes a cutter bar supported by the frame 22. The cutter bar extends along an axis that is disposed generally transverse to a direction of travel of the windrower implement 20. The cutter bar includes a plurality of cutting discs spaced along the cutter bar for rotation about respective vertical axes. Each of the cutting discs is coupled to a drivetrain to which power is coupled for causing them to rotate in appropriate directions, for delivering cut crop material to an auger 34 disposed rearward of the cutting mechanism 32.

The auger 34 may pass the crop material rearward to a crop conditioning system 36. In particular, the auger 34 may be positioned in front of and lower than the crop conditioning system 36. In operation, the design of the auger 34 enables the delivery of cut crop material into the crop conditioning system 36. The cutting mechanism 32 delivers cut crop material to the auger 34, which in turn may delivers the cut crop material rearward for further processing by the crop conditioning system 36. The crop conditioning system 36 may include, but is not limited to, an impeller style conditioning system or a pair of counter rotating conditioner rolls, as is understood in the art. The conditioned crop material is expelled rearward by the crop conditioning system 36, and may be formed into the windrow 78 or swath by upright right and left forming boards and a swath board. The cut and conditioned crop material is expelled or discharged from the crop conditioning system 36 in the rearward direction 30, whereafter the crop material moves a short distance through the air before accumulating on the ground in the formed windrow.

Referring to FIGS. 1-2, the windrower implement 20 includes a merger attachment 38. The merger attachment 38 is coupled to the frame 22 rearward of the implement head 28. The merger attachment 38 is moveable between a deployed position and a stowed position. When the merger attachment 38 is disposed in the deployed position, the merger attachment 38 is positioned relative to the implement head 28 to receive discharged crop material from the implement head 28 and convey the crop material laterally relative to the central longitudinal axis 24 to form the windrow 78 laterally offset from the central longitudinal axis 24. When the merger attachment 38 is disposed in the stowed position, the merger attachment 38 is positioned relative to the implement head 28 to not receive discharged crop material from the implement head 28 to form the windrow 78 substantially aligned with the central longitudinal axis 24 along the centerline of the windrower implement 20.

The merger attachment 38 may be positioned such that the crop material discharged from the crop conditioning system 36 falls on the merger attachment 38 instead of the ground. The crop material discharged from the crop conditioning system 36 is disposed generally along a longitudinal centerline of the windrower implement 20, between left and right ground engaging devices 26 of the windrower implement 20. The merger attachment 38 includes a moveable conveyor 40, e.g., a rotatable endless belt, which is operable to convey the crop material laterally relative to the longitudinal centerline of the windrower implement 20, and deposit the crop material on the ground at a laterally offset position relative to the central longitudinal axis 24 of the frame 22 and the centerline of the windrower implement 20. The crop material is discharged from the implement head 28 and falls onto the conveyor 40 of the merger attachment 38. The conveyor 40 moves or rotates to move the crop disposed thereon laterally outward away from the centerline of the windrower implement 20. The crop on the conveyor 40 is deposited or discharged off a distal end 76 of the conveyor 40, whereafter the crop falls to the ground forming the windrow 78 which is laterally offset from the centerline of the windrower implement 20.

The merger attachment 38 may include a lift structure 42 and a support structure 44. The support structure 44 includes the conveyor 40 for moving the crop material. The lift structure 42 may interconnect the frame 22 of the windrower implement 20 and the support structure 44. The lift structure 42 may be configured to selectively position the support structure 44 in the stowed position and the deployed position. When disposed in the stowed position, the lift structure 42 may position the support structure 44 tightly against the belly of the frame 22, such that the conveyor 40 of the support structure 44 does not engage the cut crop material discharged from the implement head 28 and the windrow 78 may be formed along the central longitudinal axis 24 of the frame 22, i.e., generally along the centerline of the windrower implement 20. When disposed in the deployed position, the lift structure 42 may position the conveyor 40 of the support structure 44 near the ground surface, such that the crop material discharged from the implement head 28 falls on the conveyor 40 of the support structure 44 for lateral movement relative to the central longitudinal axis 24, whereby the windrow 78 may be formed laterally offset form the central longitudinal axis 24. The features, components, structure, and operation of the lift structure 42 and the support structure 44 are understood by those skilled in the art, are not pertinent to the teachings of this disclosure, and are therefore not described in detail herein.

Referring to FIG. 1, the windrower implement 20 further includes a merger controller 46. The merger controller 46 is operatively coupled to the merger attachment 38 for controlling movement of the merger attachment 38 between the deployed position and the stowed position. The merger controller 46 is operable to receive inputs and data signals, and communicate a control signal to the lift structure 42. While the merger controller 46 is generally described herein as a singular device, it should be appreciated that the merger controller 46 may include multiple devices linked together to share and/or communicate information therebetween. Furthermore, it should be appreciated that the merger controller 46 may be located on the windrower implement 20 or located remotely from the windrower implement 20.

The merger controller 46 may alternatively be referred to as a computing device, a computer, a controller, a control unit, a control module, a module, etc. The merger controller 46 includes a processor 48, a memory 50, and all software, hardware, algorithms, connections, sensors, etc., necessary to manage and control the operation of the location sensor 54 and lift structure 42 of the merger attachment 38. As such, a method may be embodied as a program or algorithm operable on the merger controller 46. It should be appreciated that the merger controller 46 may include any device capable of analyzing data from various sensors, comparing data, making decisions, and executing the required tasks.

As used herein, “merger controller 46” is intended to be used consistent with how the term is used by a person of skill in the art, and refers to a computing component with processing, memory, and communication capabilities, which is utilized to execute instructions (i.e., stored on the memory 50 or received via the communication capabilities) to control or communicate with one or more other components. In certain embodiments, the merger controller 46 may be configured to receive input signals in various formats (e.g., hydraulic signals, voltage signals, current signals, CAN messages, optical signals, radio signals), and to output command or communication signals in various formats (e.g., hydraulic signals, voltage signals, current signals, CAN messages, optical signals, radio signals).

The merger controller 46 may be in communication with other components on the windrower implement 20, such as hydraulic components, electrical components, and operator inputs within an operator station of an associated work vehicle. The merger controller 46 may be electrically connected to these other components by a wiring harness such that messages, commands, and electrical power may be transmitted between the merger controller 46 and the other components. Although the merger controller 46 is referenced in the singular, in alternative embodiments the configuration and functionality described herein can be split across multiple devices using techniques known to a person of ordinary skill in the art.

The merger controller 46 may be embodied as one or multiple digital computers or host machines each having one or more processors, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and any required input/output (I/O) circuitry, I/O devices, and communication interfaces, as well as signal conditioning and buffer electronics.

The computer-readable memory 50 may include any non-transitory/tangible medium which participates in providing data or computer-readable instructions. The memory 50 may be non-volatile or volatile. Non-volatile media may include, for example, optical or magnetic disks and other persistent memory. Example volatile media may include dynamic random access memory (DRAM), which may constitute a main memory. Other examples of embodiments for memory include a floppy, flexible disk, or hard disk, magnetic tape or other magnetic medium, a CD-ROM, DVD, and/or any other optical medium, as well as other possible memory devices such as flash memory.

The merger controller 46 includes the tangible, non-transitory memory 50 on which are recorded computer-executable instructions, including a merger control algorithm 52. The processor 48 of the merger controller 46 is configured for executing the merger control algorithm 52. The merger control algorithm 52 implements a method of operating the windrower implement 20, described in detail below.

The windrower implement 20 may further include a location sensor 54. The location sensor 54 is operable to detect data related to a location of the head implement and/or the frame 22 of the windrower implement 20. He location sensor 54 may include, but is not limited to, a Global Positioning System (GPS) device or other similar location sensor 54. The location sensor 54 is disposed in communication with the merger controller 46 for communicating data therebetween. As is understood by those skilled in the art, the location sensor 54 may detect data related to the position of the head implement over a period of time in order to determine a speed of movement and a direction of movement.

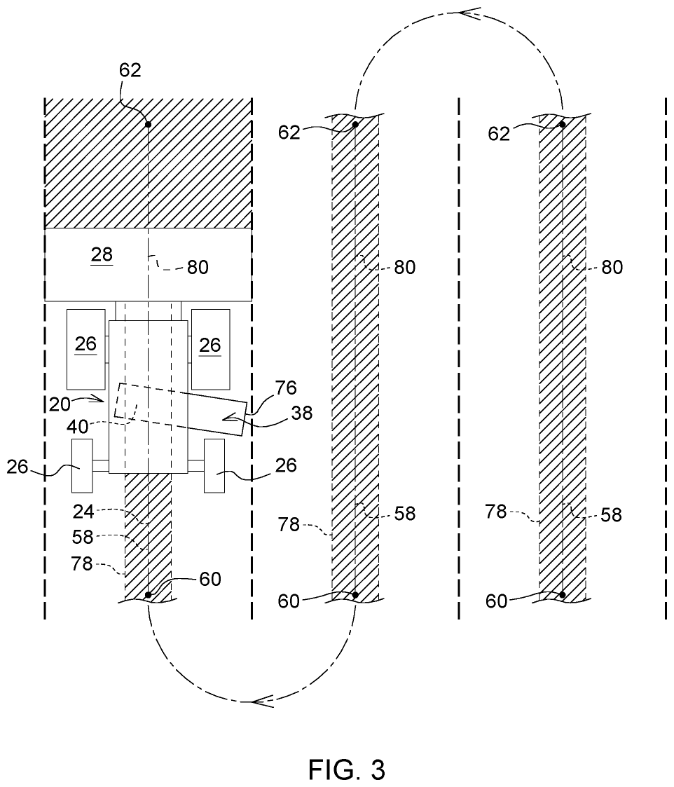

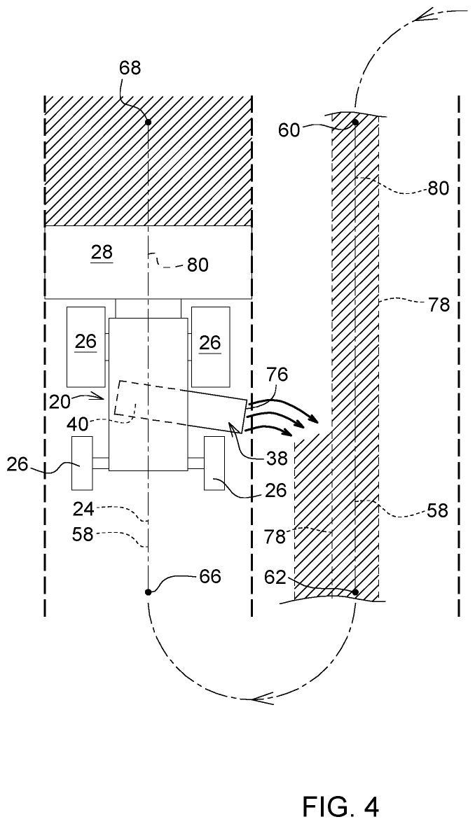

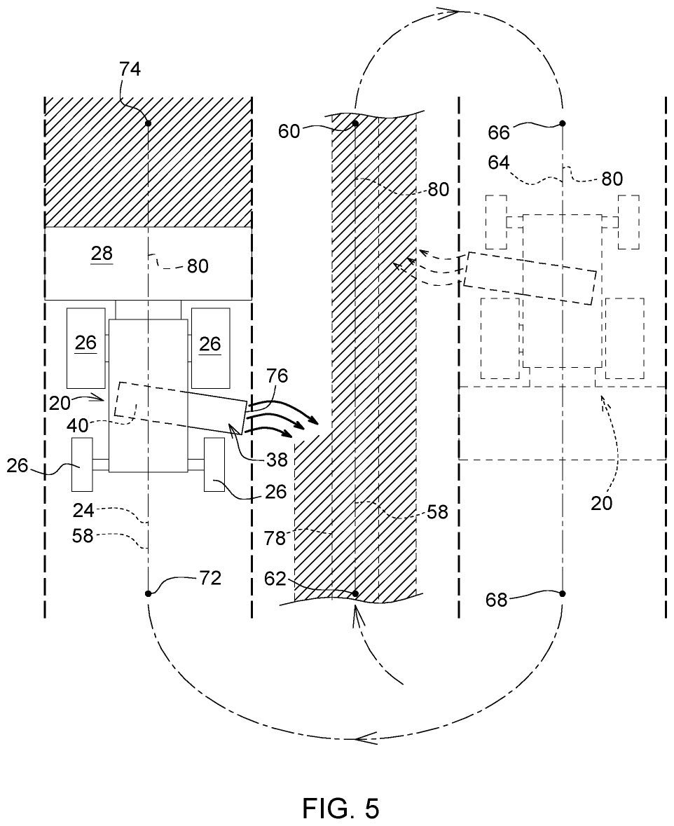

The method of operating the windrower implement 20 may begin by a user entering a user command into the merger controller 46 via an input device 56. The input device 56 may include, but is not limited to, a touchscreen display, a keyboard, a button, etc. The user command defines the desired windrow configuration for the harvest operation as one of a single pass windrow configuration generally shown in FIG. 3, a double pass windrow configuration generally shown in FIG. 4, or a triple pass windrow configuration generally shown in FIG. 5. The merger controller 46 is operable to receive the user command selecting the desired one of the single pass windrow configuration, the double pass windrow configuration, or the triple pass windrow configuration.

As is understood by those skilled in the art, when cutting crop material and forming windrows in the field, the windrower implement 20 generally makes multiple parallel passes through the field, such that the resultant windrows are arranged in a generally parallel arrangement. As used herein, the term “belly pass 58” is defined as a pass through the field in which the merger attachment 38 is disengaged and positioned in the stowed position, whereby the cut crop material is deposited generally along the centerline of the windrower implement 20 between the left and right ground engaging devices 26. Referring to FIG. 3, when the single pass windrow configuration is selected by the operator via the user command, each respective windrow 78 is formed from a belly pass 58. As such, in the single pass windrow configuration, the windrow 78 is formed from a single pass of the windrower implement 20 through the field, with each respective pass resulting in a respective windrow 78 being formed. When operating in the single pass windrow configuration, the merger attachment 38 is not engaged and/or used to form the resultant windrows.

Referring to FIG. 4, when the double pass windrow configuration is selected by the operator via the user command, each respective windrow 78 is formed from a belly pass 58 and a first merger pass 64. As used herein, the term “first merger pass 64” is defined as a pass through the field immediately adjacent to and generally parallel with the belly pass 58, with the merger attachment 38 disposed in the deployed position and operable to deposit the crop material from the first merger pass 64 onto or adjacent to the windrow 78 formed by the belly pass 58. As such, when executing the first merger pass 64, the windrower implement 20 must travel in a direction of travel that results in the distal end 76 of the conveyor 40 being positioned adjacent to the windrow 78 formed by the belly pass 58 so that the crop material from the first merger pass 64 is deposited onto the windrow. It should be appreciated that the direction of travel of the windrower implement 20 for the first merger pass 64 depends upon which side of the windrow 78 the windrower implement 20 is positioned. When the double pass windrow configuration is selected, the merger attachment 38 is disengaged while executing the belly pass 58, whereby the windrow 78 is formed along the centerline of the windrower implement 20. After completing the belly pass 58, the windrower implement 20 is aligned and/or positioned immediately adjacent to the belly pass 58 with the merger attachment 38 deployed to execute the first merger pass 64. While executing the first merger pass 64, the merger attachment 38 deposits the crop material from the first merger pass 64 onto or next to the windrow 78 formed from the belly pass 58, thereby placing the windrow 78 from two adjacent passes through the field together as a single windrow.

Referring to FIG. 5, when the triple pass windrow configuration is selected by the operator via the user command, each respective windrow 78 is formed from the belly pass 58, the first merger pass 64, and a second merger pass 70. As used herein, the term “second merger pass 70” is defined as a pass through the field immediately adjacent to and generally parallel with the belly pass 58, on an opposing side of the belly pass 58 from the first merger pass 64, with the merger attachment 38 disposed in the deployed position and operable to deposit the crop material from the second merger pass 70 onto or adjacent to the windrow 78 formed by the belly pass 58 and the first merger pass 64. When executing the second merger pass 70, the windrower implement 20 must travel in a direction of travel that results in the distal end 76 of the conveyor 40 being positioned adjacent to the windrow 78 formed by the belly pass 58 and the first merger pass 64 so that the crop material from the second merger pass 70 is deposited onto the windrow. Because the second merger pass 70 is disposed on the opposing side of the belly pass 58 relative to the first merger pass 64, it should be appreciated that the direction of travel of the windrower implement 20 for the second merger pass 70 is opposite the direction of travel for the first merger pass 64. When the double pass windrow configuration is selected, the merger attachment 38 is disengaged while executing the belly pass 58, whereby the windrow 78 is formed along the centerline of the windrower implement 20. After completing the belly pass 58, the windrower implement 20 is aligned and/or positioned immediately adjacent to the belly pass 58 with the merger attachment 38 deployed to execute the first merger pass 64. While executing the first merger pass 64, the merger attachment 38 deposits the crop material from the first merger pass 64 onto or next to the windrow 78 formed from the belly pass 58, thereby placing the windrow 78 from two adjacent passes through the field together as a single windrow. After completing the first merger pass 64, the windrower implement 20 is aligned and/or positioned immediately adjacent to the belly pass 58 on the opposite side of the belly pass 58 relative to the first merger pass 64, for movement in an opposite direction relative to the first merger pass 64, with the merger attachment 38 deployed to execute the second merger pass 70. While executing the second merger pass 70, the merger attachment 38 deposits the crop material from the second merger pass 70 onto or next to the windrow 78 formed from the belly pass 58 and the first merger pass 64, thereby placing the windrow 78 from three adjacent passes through the field together as a single windrow.

Referring to FIGS. 3-5, when either the single pass windrow configuration, the double pass windrow configuration or the triple pass windrow configuration is selected by the user, the merger controller 46 may automatically control the merger attachment 38 into the stowed position in preparation for executing the belly pass 58 for the single pass windrow configuration, the double pass windrow configuration, or the triple pass windrow configuration. In order to do so, the merger controller 46 may signal the lift structure 42 to move the support structure 44 into the stowed position.

In one implementation, the merger controller 46 may query the operator to identify a beginning 60 and/or an end 62 of the belly pass 58. The operator may define the beginning 60 and/or the end 62 of the belly pass 58 via the user input, such as by pressing a button instructing the merger attachment 38 to use the current location of the windrower implement 20 as the beginning 60 and/or the end 62 of the belly pass 58, or by entering a desired track having a start location and an end location corresponding to the beginning 60 of the belly pass 58 and the end 62 of the belly pass 58 respectively.

Upon completion of the belly pass 58, the operator may align and position the windrower implement 20 relative to the belly pass 58 for the next pass. If the single pass configuration has been selected, then the merger controller 46 may maintain the merger attachment 38 in the stowed position and the windrower implement 20 may then execute another belly pass 58. If either the double pass confirmation or the triple pass configuration has been selected, then upon completion of the belly pass 58, the merger attachment 38 may automatically control the merger attachment 38 into the deployed position in preparation for executing the first merger pass 64.

The merger controller 46 may receive data from the location sensor 54, and therefrom determine a current location of the windrower implement 20 and/or head implement, speed of travel of the windrower implement 20, and direction of travel or movement of the head implement. The merger controller 46 may track the location of the windrower implement 20 while executing the belly pass 58 to determine a location of the windrow 78 formed during the belly pass 58. The location of the windrow 78 formed during the belly pass 58 may then be save in the memory 50 as a windrow track location 80.

Referring to FIGS. 4-5, when either the double pass windrow configuration or the triple pass windrow configuration is selected, the merger controller 46 may recognize the beginning 66 of the first merger pass 64 from the current location of the head implement, the direction of movement of the head implement and the windrow track location 80. For example, if the end 62 of the belly pass 58 has been previously defined or is contemporaneously entered into the merger controller 46 by the operator, the merger controller 46 may then use the track location and the current position of the windrower implement 20 to determine and/or recognize the beginning 66 of the first merger pass 64. Upon recognizing the beginning 66 of the first merger pass 64, the merger controller 46 may control the merger attachment 38 into the deployed position in preparation of the first merger pass 64 of either the double pass windrow configuration or the triple pass windrow configuration.

When either the double pass windrow configuration or the triple pass windrow configuration is selected, the merger controller 46 may recognize the end 68 of the first merger pass 64 from the current location of the head implement, the direction of movement of the head implement and the windrow track location 80. For example, if the end 68 of the first merger pass 64 has been previously defined or is contemporaneously entered into the merger controller 46 by the operator, the merger controller 46 may then use the track location and the current position of the windrower implement 20 to determine and/or recognize the end 68 of the first merger pass 64. Upon recognizing the end 68 of the first merger pass 64, and if the single pass windrow configuration was selected, the merger controller 46 may control the merger attachment 38 into the stowed position in preparation of the next belly pass 58. If the double pass windrow configuration was selected, upon recognizing the end 68 of the first merger pass 64, the merger controller 46 may maintain the merger attachment 38 in the deployed position in preparation for the second merger pass 70.

Referring to FIG. 5, when the triple pass windrow configuration has been selected, and upon determining or identifying the end 68 of the first merger pass 64, the merger controller 46 may recognize the beginning 72 of the second merger pass 70 from a current location of the head implement, a direction of movement of the head implement and the windrow track location 80. Upon recognizing the beginning 72 of the second merger pass 70, the merger controller 46 may automatically control the merger attachment 38 into the deployed position in preparation for executing the second merger pass 70 when the triple pass configuration has been selected. The merger controller 46 may recognize the end 74 of the second merger pass 70 from the current location of the head implement, the direction of movement of the head implement and the windrow track location 80. Upon completion of the second merger pass 70, i.e., upon recognizing the end 74 of the second merger pass 70, the merger controller 46 may then repeat the process for the creation of the next windrow.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

What is claimed is:

1. A windrower implement comprising:
a frame extending along a central longitudinal axis between a forward end and a rearward end relative to a direction of travel during operation;
an implement head attached to the frame proximate the forward end thereof, wherein the implement head is operable to cut standing crop material and discharge cut crop material in a rearward direction along the central longitudinal axis;
a merger attachment coupled to the frame rearward of the implement head, wherein the merger attachment is moveable between a deployed position in which the merger attachment is positioned relative to the implement head to receive discharged crop material from the implement head and convey the crop material laterally relative to the central longitudinal axis to form a windrow laterally offset from the central longitudinal axis, and a stowed position in which the merger attachment is positioned relative to the implement head to not receive discharged crop material from the implement head to form the windrow substantially aligned with the central longitudinal axis along a center line of the frame;
a merger controller operatively coupled to the merger attachment for controlling movement of the merger attachment between the deployed position and the stowed position, the merger controller having a processor and a memory having a merger control algorithm stored thereon, wherein the processor is operable to execute the merger control algorithm to:
receive a user command selecting one of a single pass windrow configuration in which the windrow is formed from a belly pass, and a double pass windrow configuration in which the windrow is formed from the belly pass and a first merger pass;
automatically control the merger attachment into the stowed position when executing the belly pass for the single pass windrow configuration and the double pass windrow configuration when either the single pass windrow configuration or the double pass windrow configuration is selected; and
automatically control the merger attachment into the deployed position when executing the first merger pass when the double pass windrow configuration is selected.

2. The windrower implement set forth in claim 1, further comprising a location sensor operable to detect data related to a location of the head implement, wherein the processor is operable to execute the merger control algorithm to determine a current location of the head implement and direction of movement of the head implement from the data detected by the location sensor.

3. The windrower implement set forth in claim 2, wherein the processor is operable to execute the merger control algorithm to determine a location of the windrow formed during the belly pass and save the location of the windrow formed during the belly pass in the memory as a windrow track location.

4. The windrower implement set forth in claim 3, wherein the processor is operable to execute the merger control algorithm to recognize a beginning of the first merger pass from the current location of the head implement, the direction of movement of the head implement and the windrow track location, when the double pass windrow configuration is selected.

5. The windrower implement set forth in claim 4, wherein the processor is operable to execute the merger control algorithm to automatically control the merger attachment into the deployed position upon recognizing the beginning of the first merger pass when the double pass windrow configuration is selected.

6. The windrower implement set forth in claim 1, wherein the processor is operable to execute the merger control algorithm to receive the user command selecting one of the single pass windrow configuration, the double pass windrow configuration, and a triple pass windrow configuration in which the windrow is formed from the belly pass, the first merger pass and a second merger pass.

7. The windrower implement set forth in claim 6, wherein the processor is operable to execute the merger control algorithm to automatically control the merger attachment into the stowed position when executing the belly pass for the triple pass windrow configuration.

8. The windrower implement set forth in claim 6, wherein the processor is operable to execute the merger control algorithm to automatically control the merger attachment into the deployed position when executing the first merger pass and the second merger pass for the triple pass windrow configuration.

9. The windrower implement set forth in claim 6, wherein the processor is operable to execute the merger control algorithm to recognize a beginning of the first merger pass and a beginning of the second merger pass from a current location of the head implement, a direction of movement of the head implement and a windrow track location, when the triple pass windrow configuration is selected.

10. The windrower implement set forth in claim 9, wherein the processor is operable to execute the merger control algorithm to automatically control the merger attachment into the deployed position upon recognizing the beginning of the first merger pass or the beginning of the second merger pass when the triple pass windrow configuration is selected.

11. A windrower implement comprising:
a frame extending along a central longitudinal axis between a forward end and a rearward end relative to a direction of travel during operation;
an implement head attached to the frame proximate the forward end thereof, wherein the implement head is operable to cut standing crop material and discharge cut crop material in a rearward direction along the central longitudinal axis;
a merger attachment coupled to the frame rearward of the implement head, wherein the merger attachment is moveable between a deployed position in which the merger attachment is positioned relative to the implement head to receive discharged crop material from the implement head and convey the crop material laterally relative to the central longitudinal axis to form a windrow laterally offset from the central longitudinal axis, and a stowed position in which the merger attachment is positioned relative to the implement head to not receive discharged crop material from the implement head to form the windrow substantially aligned with the central longitudinal axis along a center line of the frame;
a merger controller operatively coupled to the merger attachment for controlling movement of the merger attachment between the deployed position and the stowed position, the merger controller having a processor and a memory having a merger control algorithm stored thereon, wherein the processor is operable to execute the merger control algorithm to:
receive a user command selecting one of a single pass windrow configuration in which the windrow is formed from a belly pass, and a double pass windrow configuration in which the windrow is formed from the belly pass and a first merger pass;
automatically control the merger attachment into the deployed position when executing the first merger pass when the double pass windrow configuration is selected.

12. The windrower implement set forth in claim 11, further comprising a location sensor operable to detect data related to a location of the head implement, wherein the processor is operable to execute the merger control algorithm to determine a current location of the head implement and direction of movement of the head implement from the data detected by the location sensor.

13. The windrower implement set forth in claim 12, wherein the processor is operable to execute the merger control algorithm to determine a location of the windrow formed during the belly pass and save the location of the windrow formed during the belly pass in the memory as a windrow track location.

14. The windrower implement set forth in claim 13, wherein the processor is operable to execute the merger control algorithm to recognize a beginning of the first merger pass from the current location of the head implement, the direction of movement of the head implement and the windrow track location, when the double pass windrow configuration is selected.

15. A method of operating a windrower implement, the method comprising:
entering a user command into a merger controller via an input device to select one of a single pass windrow configuration in which a windrow is formed from a belly pass, a double pass windrow configuration in which the windrow is formed from the belly pass and a first merger pass, or a triple pass windrow configuration in which the windrow is formed from the belly pass, the first merger pass and a second merger pass;
determining a beginning of the belly pass;
controlling a merger attachment into a stowed position at the beginning of the belly pass when any one of the single pass windrow configuration, the double pass windrow configuration, or the triple pass windrow configuration are selected;
determining a beginning of the first merger pass;
automatically controlling, with the merger controller, the merger attachment into a deployed position at the beginning of the first merger pass when one of the double pass windrow configuration or the triple windrow configuration are selected.

16. The method of operating the windrower implement set forth in claim 15, further comprising sensing data related to a current location and direction of travel of the windrower implement, and determining the current location and the direction of travel of the windrower implement with the merger controller.

17. The method of operating the windrower implement set forth in claim 15, further comprising determining a location of the windrow formed during the belly pass and saving the location of the windrow formed during the belly pass in the memory as a windrow track location.

18. The method of operating the windrower implement set forth in claim 17, wherein determining the beginning of the first merger pass is further defined as determining the beginning of the first merger pass from the windrow track location, the current location of the windrower implement and the current direction of travel of the windrower implement.

19. The method set forth in claim 15, further comprising automatically controlling, with the merger controller, the merger attachment into the deployed position at a beginning of the second merger pass when the triple windrow configuration is selected.
